(19) United States
(12) Patent Application Publication
(10) Pub. No.: US 2004/0216254 A1
(43) Pub. Date: Nov. 4, 2004

(54) Sectoral ring brush

(75) Inventor: Peter Ueberall, Uetersen (DE)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: Trojan Technologies Inc.

(21) Appl. No.: 10/428,156

(22) Filed: May 2, 2003

(51) Int. Cl. B08B 9/023

(52) U.S. Cl. 15/104.04

(57) ABSTRACT

A sectoral ring brush with inside trimming for keeping clear and/or cleaning cylindrical bodies, preferably quartz cladding tubes in UV disinfection units, especially in UV disinfection sluices for the disinfection of waste water, characterized in that the sectoral ring brush consists of sectoral elements whose trimming can be integrated prior to the installation in a housing, with the sectoral element being fastened individually or in a connected fashion, e.g. by connecting bridges on the circumference, in a ring-shaped housing.

### BACKGROUND OF THE INVENTION

1. Field of the Invention

The present invention relates to a sectoral ring brush for keeping clear and/or cleaning cylindrical bodies, preferably quartz cladding tubes in ultraviolet (UV) disinfection units, especially in UV disinfection sluices for the disinfection of waste water.

2. Description of the Prior Art

In order to prevent an impermissibly quick decrease in the performance of UV units which is caused by the increasing accumulation of fouling materials on the quartz cladding tubes where the UV radiators are situated, a number of cleaning apparatus have been developed which are moved back and forth on the quartz cladding tubes.

It is known in the art that such quartz cladding tubes unavoidably contain recesses as well as ovalities and convex shaping faults. These faults typically are caused during production of the quartz cladding tubes by presence of elongate air bubbles in the quartz melt which can form ribs causing the out of roundness faults.

A reliable means by which such fault-containing quartz cladding tubes may be clenaned is with a UV-resistant round brush of optimal arrangement and type of bristles. The hardness and flexibility of the bristles may be selected to achieve discharge of the removed dirt.

Unfortunately, according to the state of the art, there remains a need for truly useful round or annular brushes with inside trimming especially in the dimensions of the smaller quartz cladding tube—e.g., from about 25 mm to about 35 mm. It would be particularly advantageous if such a ring brush could be produced in a relatively cost-effective way as sectoral ring brushes.

### SUMMARY OF THE INVENTION

It is an object of the present invention to provide a novel sectoral ring brush for keeping clear and/or cleaning cylindrical bodies.

It is another object of the present invention to provide a novel cleaning apparatus for use in an ultraviolet (UV) disinfection units.

It is yet another object of the present invention to provide a novel cleaning apparatus for use in a UV disinfection sluice for the disinfection of waste water.

Accordingly, in one of its aspects, the present invention provides a sectoral ring brush with inside trimming for keeping clear and/or cleaning cylindrical bodies, preferably quartz cladding tubes in UV disinfection units, especially in UV disinfection sluices for the disinfection of waste water, characterized in that the sectoral ring brush consists of sectoral elements whose trimming can be integrated prior to the installation in a housing, with the sectoral element being fastened individually or in a connected fashion, e.g. by connecting bridges on the circumference, in a ring-shaped housing.

### BRIEF DESCRIPTION OF THE DRAWINGS

Embodiments of the present invention will be described with reference to the accompanying drawings, wherein like reference numerals denote like parts, and in which:

FIG. 1a illustrates a first preferred embodiment of the present cleaning system;

FIG. 1b is a sectional view along line ABC in FIG. 1;

FIGS. 2 and 3a illustrate a second preferred embodiment of the present cleaning system;

FIG. 3b is a section view along line ABC in FIG. 3a;

FIGS. 4 and 5 illustrate, in two dimensions, elements of the brush shown in FIGS. 2, 3a and 3b.

### DETAILED DESCRIPTION OF THE PREFERRED EMBODIMENTS

UV disinfection units for water and waste water generally attain the full de-germinating (disinfection) output, i.e., the one corresponding to the momentary state of the UV radiators, when the UV radiation as emitted by the UV radiators reaches the water to be disinfected to the highest possible extent through the quartz cladding tubes in which the UV radiators are installed for cooling and for protection against humidity.

Favorable cladding tubes allow more than 90 percent of the UV output of the UV radiators to pass through. However, even slight soiling, noticeably impairs the UV radiation transmittance. Deposits form rapidly on the cladding tubes especially in the case of UV disinfection of relatively clear waste water. The deposits originate from still present organic residues in the cleared waste water. Within days, a thin slimy layer forms that does not considerably impair the disinfection effect. This initial layer can be wiped away easily. In the case of a further thickening of such dirt layers, a thicker dirt layer will gradually form which will impair the UV radiation transmittance to an even higher extent if there is no cleaning of the surface of the cladding tubes. This thicker layer will gradually harden, particularly due to the intensive UV radiation in close proximity to the UV radiators and the thus ensuing heating, so that the removal of said layer will become a problem because the UV output of the unit will continually drop until the unit needs to be switched off because it has fallen below the minimum UV output. At this point the cladding tubes need to be removed and cleaned.

There are also UV units with cleaning apparatuses for cladding tubes such as wipers with spatula-shaped wiper rings or with softer packings or felt-like inserts that are moved back and forth on the cladding tubes. It is hoped that these wipers can also penetrate the unavoidable recesses on the quartz cladding tubes as well as follow the convex irregularities of such quartz cladding tubes. Even flat cans which are sealed on both sides and are filled with cleaning chemicals are already in use, although in such cases it is no longer possible to speak of a “chemical-free” UV de-germination. These numerous efforts show very clearly that on the one hand an automatic “in operation”cleaning is important and that on the other hand no truly satisfactory solution has yet been found.

An effective tool for cleaning quartz tube surfaces is a round brush with inside trimming which is guided in a combination of longitudinal and rotational movement over the quartz tubes. Brushes whose requirements are listed below in closer detail can be used in a truly effective way for such tasks. The mechanical guidance of these brushes is not the object of this application; a useful proposal for the realization of the correct and effective movement of such round brushes which remains within reasonable limits concerning the complexity of the mechanism can be taken from copending German patent application P 100 32 645.5. To the knowledge of the present inventor, the production of suitable round brushes for this use, especially in the mostly small diameter range from about 20 mm, is currently not viable because such ring brushes are currently not commercially available.

The industrial production of brushes of all kinds occurs according to the state of the art in most cases by means of automatic punching machines. The automatic punching machines charge pre-drilled holes in the brush bodies with bunches of bristles which are prepared with respect to their length and diameter. When the standard tool withdraws from the hole in order to charge the next one, the bunch of bristles remains rigidly clamped in the bore. It is possible to insert bristles in a practically plane as well as convexly curved way as well as circular brush bodies on the circumference with such automatic punching machines. It is apparent that such a method is not suitable for ring brushes with inside trimming, especially with small diameters of from about 20 and to about 100 mm.

If a ring brush, e.g., a ring brush with inside trimming, is to be produced, one usually first produces a straight brush strip which consists of a U-shaped metal rail in which the bristles are pressed in with a wire and are then clamped. The brush strip is then shaped into a cylindrical spiral, which occurs in such a way that from the obtained brush spiral, individual or several windings are cut out and can be pressed flat into a ring structure. In this way it is possible to arrange the ring trimming, i.e. the ring of bristles, on the inside or outside. This production method is entirely sufficient for many applications, e.g., when shafts, threaded spindles or ball winch drives are to be protected flexibly from dust, shavings or oil mist. Ring-shaped brushes that are produced in this manner are not suitable, however, for permanently keeping clear as well as the periodic cleaning of quartz cladding tubes in which usually the UV radiators of UV disinfection units are installed.

The requirements placed on ring brushes for cladding tube cleaning in UV units are numerous, since optimally, they should:

a. offer a perfect fit concerning the correct seat on the circumference of the cladding tube;

b. be capable of being installed with adequate fit in their holding and movement element;

c. be substantially resistant to UV or at least UV-stabilized;

d. be hard enough to even gradually brush off incrustations;

e. be soft and resilient enough to be able to follow the unavoidable deviations from the circular shape which are inherent in virtually all commercially available quartz tubes as well as the rib-shaped elevations on the same which inevitably also arise from longish bubbles in the doughy molten quartz material;

f. be able to brush away or brush off dirt and, especially, slimy deposits which originate from organic material from the waste water; and

g. comprise free rinsing channels in sufficient number so that the brushed-off dirt particles that are conveyed by the own movement of the brush can finally be entrained by the slow flow into the UV waste water disinfection sluices.

To the knowledge of the present inventor, round brushes with inside trimming which actually meet the requirements as listed under a) through g) cannot be produced according to the state of the art and in particular on currently used automatic punching machines.

However, according a preferred embodiment of the invention, it is possible to produce a cleaning system having some or all of aforementioned requirements a) through g).

In its preferred form, the present invention essentially consists of assembling a round brush of individual segments and/or individual elements into a ring-shaped housing which each have their own trimmings which can be punched or sheared into the individual sectoral elements as long as the sectoral brush has not yet been assembled in the housing. As a result, the inner round shape which is so difficult to achieve with the means according to the state of the art and the required rinsing channels according to item g) of the above listed requirements are simply obtained as in the situation where the number of segments is large enough. It is irrelevant that individual segments are produced and they are fastened individually next to one another into a holding ring or a larger number of smaller brush segments with an intermediate connection in order to insert it then as a kind of a flexible strip, e.g. into a groove of a holding ring. Only the fastening at a place in the ring is necessary against turning, which among other things leads to the advantage of this special application of the preferred embodiment of the invention insofar as a fixing is necessary at all, because a flexible strip, when made for example of a plastic material such as PE and provided with the correct spring tension, will obviously clamp strongly enough in the housing by itself. The sectoral brush does not lose its characteristics in this process. The individual sectorial elements are only fixed differently in the holding ring.

According to the preferred embodiment of the invention, the relevant aspect is that a round brush is made of sectoral elements or ring-shaped individual elements capable of being assembled and which can be trimmed with bristles with conventional production means such as automatic punching machines in any desired manner as long as they have not yet been inserted in a ring-shaped housing. It is irrelevant whether they are individual structures or such that are connected in any way whatsoever. In this way precision brushes with inside trimming up to an inner diameter down to about 20 mm can be produced very easily. The relevant aspects of preferred embodiments of the invention are described with reference to the following two embodiments.

### EMBODIMENT #1

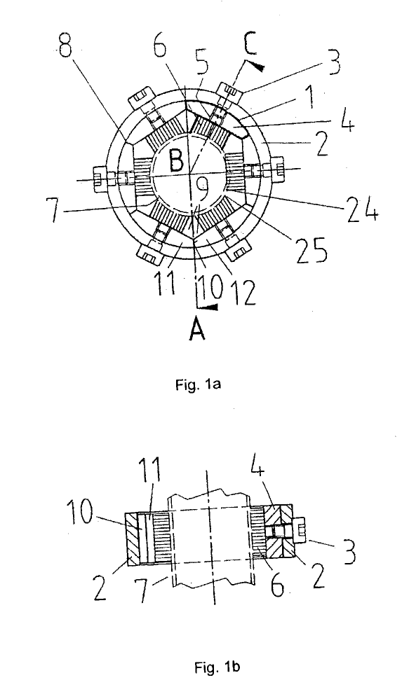

As is shown in FIG. 1a, the sectoral ring brush is composed by way of example of six concentrically arranged segment or element bodies 4 with a trimming 6 which is fitted into a ring housing 2. The individual segments each comprise an inner thread 5 in which a screw 3 can grasp and pull the segment tightly against the inner wall of the ring housing. The individual segment bodies touch each other with the surfaces 10. The trimming 6 facing the center is not quite as wide as the segment body 4. The rinsing channel 9 is thus obtained therefrom between two segment bodies each.

Assuming that reference numerals 11 and 12 are adjacent segments, then they touch each other at the surfaces 10 and form the rinsing channel 9. Reference numeral 7 is a quartz cladding tube for a UV radiator in a UV disinfection sluice which is to be kept clear and/or cleaned by the sectoral ring brush by the rotating and longitudinal movement.

FIG. 1b shows the sectional view along line ABC in FIG. 1a. In the sectional view BC on the right-hand side the central sectional view through a sectorial element 4 is shown with the ring housing 2 and the screw 3 and the trimming 6 which rests on the quartz cladding tube 7. On the left-hand side in FIG. 1b the sectional view is shown precisely between two sectorial elements 11 and 12. Reference numeral 10 shows the two contact surfaces with which the two sectorial elements rest against each other.

Reference has already been made that the trimming of the individual sectorial element can be arranged and sheared as required as long as the same is not yet installed in the ring housing. As a result, a shearing tool can be used to arrange the punched trimming 25 in a circular way, i.e., precisely to the circumference of the circular quartz cladding tube 7, or the trimming can be cut in a straight way, i.e. it is arranged with a tangential edge with respect to the quartz cladding tube 7.

### EMBODIMENT #2

The second embodiment shows in an exemplary manner another application of a preferred embodiment of the invention in the case that a plurality of individual segments with a preferably single-row brush trimming can be fixed without any additional fastening elements such as screws in a self-holding manner in a mounting ring. The individual rows of trimming bunches of the elements do not need any round shearing cut so as to still rest in a round manner on the cylindrical body to be cleaned. It can be said that brushes according to this design are best suitable for the cleaning of quartz cladding tubes in UV units and can be produced in the best cost-effective way with conventional production means such as plastic injection machines and automatic punching machines.

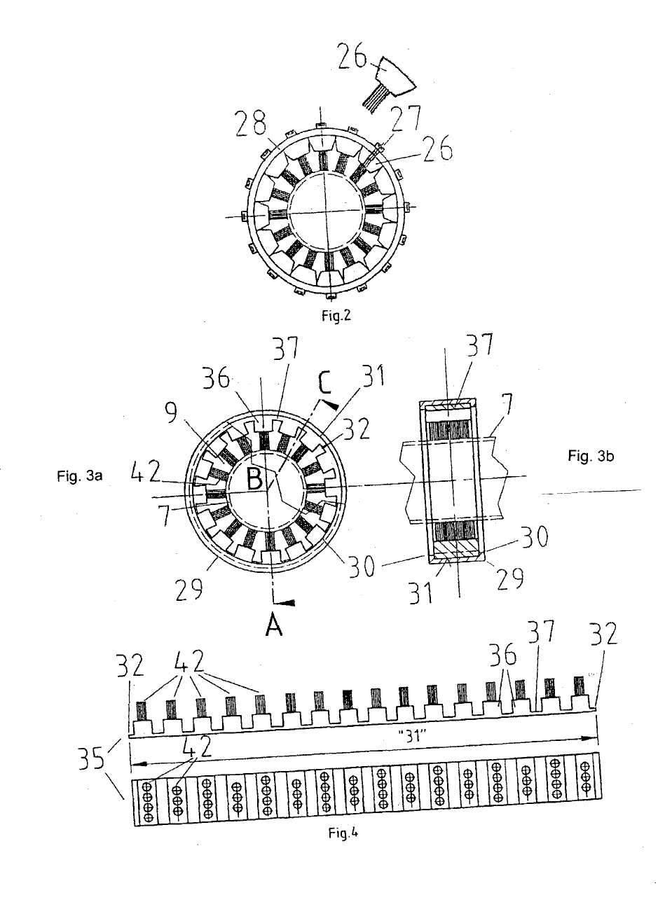

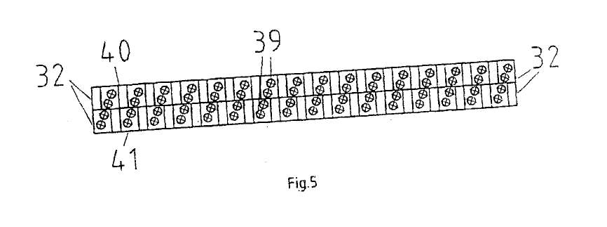

A round brush according to this embodiment and based on the design according to FIG. 2 is shown in FIGS. 3a, 3b and 4. FIG. 2 shows a design similar to that of Embodiment 1 (FIG. 1a), but with a much higher number of sectoral elements 26 which are each provided with a fastening screw 27 for fastening in a mounting ring 28. It will be clear that this type of fastening, especially in the case of small inside diameters, for example of about 25 mm, would lead to an unreasonable amount of mounting work.

It is therefore advantageous to be able to fasten the sectoral elements 26 in a different fashion. A solution is to connect them with each other by means of connecting bridges 37 and to thus produce them in one piece, e.g. as a plastic injected product. One thus obtains a flexible strip whose spring tension can be determined at will through the thickness of the connecting bridges. These strips can be inserted in a rolled-up and compressed way into a groove of the mounting ring where it will adapt to the provided rounding like a resilient insert clasp and will remain fixed without any further fastening when it has the correct tension which only depends on the design and the construction.

A brush thus designed is shown by way of example in FIGS. 3a, 3b and 4.

Reference numeral 35 relates to the brush strip or spring claps which consists of the sectoral elements 36 which are connected with the connecting bridges 37 and are inserted in the ring housing 29. Reference numeral 32 relates to the interfaces which rest against each other in the mounted state. The ring housing 29 is to have a narrow collar 30 on each side, so that an inside groove is formed with the floor 31 into which the clasp-like strip 35 fits precisely with the sectoral brush elements. Depending on the number and shape of the sectoral elements 36 one can obtain relatively wide rinsing channels 9 for discharging the brushed-off dirt. The single-row trimming 42 sits smoothly in a “round” fashion on the quartz cladding tube 7 in the case of correct dimensioning when it was shorn either straight or not straight.

It may be appropriate to arrange the single-row trimming in an inclined manner, as shown in FIG. 5. This is achieved in such a way for example that the inclined trimming 39 is divided up among two strips 32 which are inserted in an offset manner. In FIG. 5, reference numeral 41 relates to the sectoral elements and reference numeral 40 to the connecting bridges which determine the flexibility and spring tension. In this way one can also achieve an overlapping of the inclined trimmings 39, which is advisable when the brushes are moved back and forth without turning only longitudinally over the quartz cladding tubes to be cleaned.

With a round brush according to Embodiment 2 on the basis of the preferred aspect of the present invention, it is easily possible to fulfill all requirements as listed above under a) through g). Both the mounting ring as well as the brush clasp and the resilient brush strip can be produced in a cost-effective way as plastic parts in injection molding machines.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A sectoral ring brush with inside trimming for keeping clear and/or cleaning cylindrical bodies, preferably quartz cladding tubes in UV disinfection units, especially in UV disinfection sluices for the disinfection of waste water, characterized in that the sectoral ring brush consists of sectoral elements whose trimming can be integrated prior to the installation in a housing, with the sectoral element being fastened individually or in a connected fashion, e.g. by connecting bridges on the circumference, in a ring-shaped housing.

2. A sectoral ring brush as claimed in claim 1, characterized in that the sectoral elements are provided with a single-row or at least such a narrow trimming that rinsing channels for discharging the dirt removed by the sectoral ring brush are obtained between the sectoral elements which are built into the housing.

3. A sectoral ring brush as claimed in claim 1 and 2, characterized in that the sectoral elements are connected at the circumference by a connecting member such as a bridge and the sectoral elements are prior to the installation a strip-like straight work piece which during the round bending prior to the installation in the housing is provided with a sufficient mechanical tension for slip-proof self-holding in the housing seat and which work piece can be injection-molded in one piece from plastic material, e.g. polyethylene (PE), and in which a trimming can be incorporated on conventional punching machines or with other machines.

4. A sectoral brush as claimed in claim 1 to 3, especially claim 3, characterized in that the trimming is attached in an inclined fashion with respect to the longitudinal edge of the strip-like work piece.

5. A sectoral brush as claimed in claim 1 to 4, characterized in that all parts of the sectoral ring brush are made of a UV-proof or UV-stabilized material.
